(19) United States
(12) Patent Application Publication
(10) Pub. No.: US 2009/0021511 A1
(43) Pub. Date: Jan. 22, 2009

(54) Voltaic Level Adjusting Circuit, Method, and Display Apparatus Comprising the Same

(75) Inventor: Chung-Chun Chen, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORP., Hsinchu (TW)

(21) Appl. No.: 11/877,960

(22) Filed: Oct. 24, 2007

(30) Foreign Application Priority Data
Jul. 17, 2007 (TW) 96125990

(51) Int. Cl. G09G 5/00

(52) U.S. Cl. 345/214

(57) ABSTRACT

A voltaic level adjusting circuit, a method, and a display apparatus having at least one data line are provided. The voltaic level adjusting circuit comprises a capacitor and at least one switch. The capacitor is charged to a voltaic level after receiving a reference voltage. The at least one switch is electrically connected to the at least one data line and the capacitor. A voltaic level of the at least one data line is adjusted by the voltaic level of the capacitor while the switch is turned on.

This application claims the benefit of priority based on Taiwan Patent Application No. 096125990 filed on Jul. 17, 2007, the contents of which are incorporated herein by reference in their entirety.

### BACKGROUND OF THE INVENTION

1. Field of the Invention

The present invention relates to a display apparatus, a voltaic level adjusting circuit and method for adjusting the voltaic level of the display apparatus.

2. Description of Related Art

Flat panel displays (FPDs) have been developed over recent years and gradually replaced traditional cathode radiation tube (CRT) displays. Nowadays, major flat displays comprise organic light-emitting diodes (OLED) displays, plasma display panels (PDPs), liquid crystal displays (LCDs), and field emission displays (FEDs). The LCD has become the most popular display due to its properties of low power consumption, light weight, high resolution and etc.

The ordinary LCD comprises a pixel array with several pixels and a driving circuit. Each pixel of the pixel array consists of a pixel switch and a liquid crystal capacitor, and each pixel of the pixel array can be turned on or off with a driving circuit.

To consumer a low amount of power, the operation voltage of the driving circuit is decreased. The common voltage (Vcom) of the ordinary LCD is produced by an alternating current (AC) driver. However, the common voltage produced by the alternating current driver affects the voltaic level shifts of a pixel capacitor, floating lines, and especially the voltaic level shift of each data line. More specifically, the capacitance of each data line is greater than that of the pixel capacitor. When the pixel switches are turned on, the voltaic level shift of each data line is dramatically affected. The voltaic level of each data line shifts while the pixels are driven, and results in an increase in the driving voltage. To prevent an increased driving voltage, the driving circuit must provide a larger voltage for driving.

In response to the above-mentioned issue, the common solution is to electrically connect each data line with a fixed voltage supply, and then pre-charge the capacitance of each data line by controlling the operation time of the fixed voltage supply. The voltaic level of each data line can then be resolved, thereby reducing the driving voltage and time for driving the pixels. Unfortunately, use of the common voltage consumes power and results in a greater voltaic level shift of the common voltage.

Accordingly, the objective of manufacturing LCDs is to control the voltaic level of the data lines in an adapted range and to improve the ability of the driving circuit to provide the voltage to reduce the time for driving pixels.

### SUMMARY OF THE INVENTION

In view of the above-mentioned issue, the present invention provides a voltaic level adjusting circuit and a method for adjusting a voltaic level of at least one data line utilizing a capacitor and conduction of at least one switch.

One objective of the invention is to provide a voltaic level adjusting circuit for use in a display apparatus. The display apparatus has at least one data line. The voltaic level adjusting circuit comprises a capacitor and at least one switch. The capacitor is charged to a voltaic level after receiving a reference voltage. The at least one switch is electrically connected to the at least one data line and the capacitor. A voltaic level of the at least one data line is adapted to be adjusted by the voltaic level of the capacitor while the at least one switch is turned on.

Another objective of the present invention is to provide a display apparatus, which comprises at least one data line and an above-mentioned voltaic level adjusting circuit. A voltaic level of the at least one data line is adjusted using the voltaic level adjusting circuit.

Yet further another objective of the present invention is to provide a method for adjusting a voltaic level. The method is used in a display apparatus with at least one data line. The method comprises the follow steps: providing a capacitor; charging the capacitor to a voltaic level according to a reference voltage; providing at least one switch; and adjusting a voltaic level of the at least one data line via the voltaic level of the capacitor while the at least one switch is turned on.

The present invention applies a capacitor and at least one switch to adjust the voltaic level of at least one data line of the display apparatus to control the voltaic level of at least one data line in an adapted range. The driving circuit is then capable of providing the voltage while decreasing the time for driving the pixels.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates a diagram of the first embodiment according to the present invention.

FIG. 2 illustrates a diagram of the second embodiment according to the present invention.

FIG. 3 illustrates a flow chart of the second embodiment according to the present invention.

### DESCRIPTION OF EMBODIMENTS

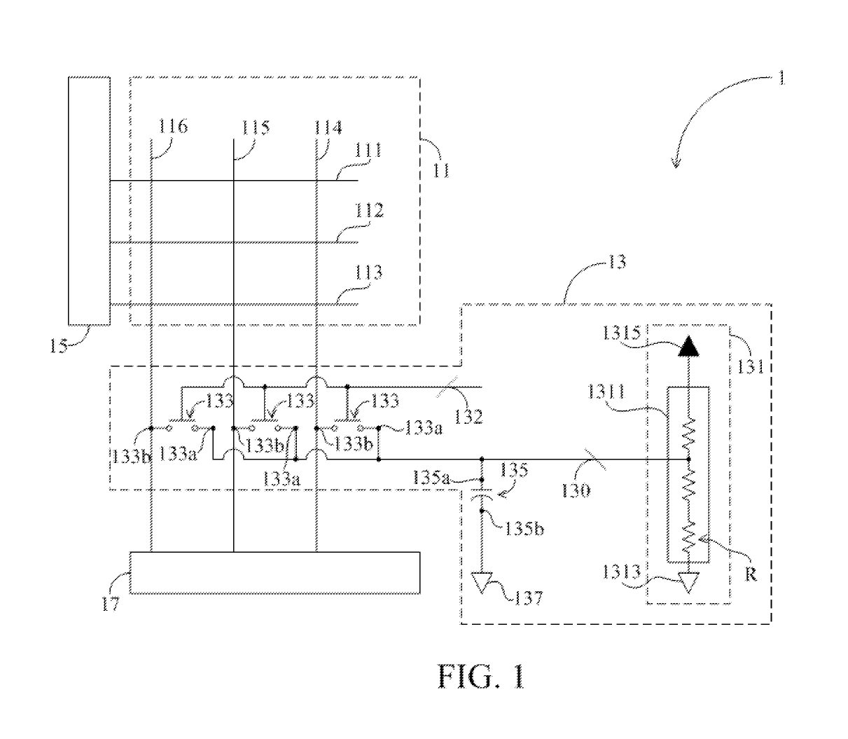

As shown in FIG. 1, the first embodiment of the present invention is a display apparatus 1. The display apparatus 1 comprises a pixel array 11, a voltaic level adjusting circuit 13, and peripheral circuits 15 and 17. The pixel array 11 has a plurality of scan lines (shown as 111, 112, and 113 in FIG. 1) and a plurality of data lines (shown as 114, 115, and 116 in FIG. 1). The voltaic level adjusting circuit 13 comprises a reference voltage circuit 131, a plurality of first switches 133 and a capacitor 135. The reference voltage circuit 131 is used to produce a reference voltage 130. The first switches 133 are electrically connected to the corresponding scan lines 114, 115, and 116 and the capacitor 135. The peripheral circuit 15 provides a driving voltage to the scan lines 111, 112, and 113, while the peripheral circuit 17 provides a driving voltage to the data lines 114, 115, and 116. The voltaic level adjusting circuit 13 is deposited between the peripheral circuit 17 and the data lines 114, 115, and 116 to adjust the voltaic level of the data lines 114, 115, and 116.

The capacitor 135 has a first electrode 135a and a second electrode 135b. The first electrode 135a of the capacitor 135 is electrically connected to the reference voltage 130, while the second electrode 135b of the capacitor 135 is electrically connected to a first power source 137. The capacitor 135 is charged to a voltaic level via the reference voltage 130 and the first power source 137. In the present embodiment, the reference voltage 130, for example, approximates to the center of common voltage of the display apparatus 1 so that the reference voltage 130 can control the voltaic level of the data lines 114, 115, and 116 in an adapted range. As a result, the peripheral circuit 17 is able to provide the voltage and reduce the time needed for driving the pixel array 11 of the display apparatus 1.

Each of the first switches 133 has a first end 133a and a second end 133b. Each of the first ends 133a of the first switches 133 is electrically connected to the first electrode 135a of the capacitor 135. Similarly, each of the second ends 133b of the first switch 133 is electrically connected to the corresponding data lines 114, 115, and 116.

The reference circuit 131 has a dividing module 1311 which is electrically connected to a second power source 1313 and a third power source 1315. The dividing module 1311 has a plurality of resistors R to first divide the difference between the second power source 1313 and the third power source 1315, and then, to provide the reference voltage 130.

The data lines 114, 115, and 116 are electrically connected to the capacitor 135 via the first switches 133 while the first switches 133 are turned on according to a first signal 132. Then, the voltaic level of the data lines 114, 115, and 116 are adjusted by the voltaic level of the capacitor 135. In other words, the capacitor 135 can adjust the voltaic level of the data lines 114, 115, and 116 using the previously charged voltaic level, and then control the voltaic levels of the data lines. The first signal 132 can be provided by the peripheral circuits 15 and 17, or other control circuits in the display apparatus 1 (not shown). However, people skilled in this field may use various circuits for achieving the goal of providing the first signal 132, and thus no unnecessary detail is given here.

In the present embodiment, the first power source 137 and the second power source 1313 provide, for example, ground signals, or 0 volt signals. The number of the resistors R in the diving module 1311 is not limited to those presented here. Furthermore, it is not limited the means to divide the difference between the second power source 1313 and the third power source 1315 by the plurality of resistors R. People skilled in this field may use other ways to divide the voltage for achieving the goal of dividing the voltage, and thus no unnecessary detail is given here.

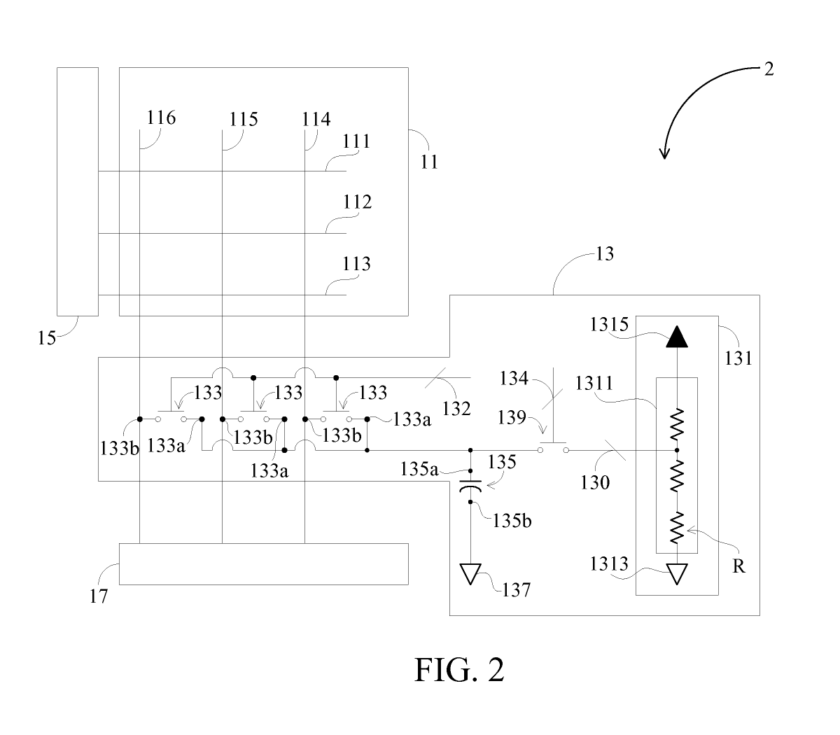

As shown in FIG. 2, a second embodiment of the present invention is another display apparatus 2. The display apparatus 2 is similar to the foregoing display apparatus 1, in which the difference between the two embodiments is that the voltaic level adjusting circuit 13 further comprises a second switch 139 in the second embodiment. The second switch 139 is electrically connected to the reference voltage circuit 131 and the first electrode 135a of the capacitor 135. The second switch 139 which is controlled by a second signal 134 is used to avoid the shift of the reference voltage 130 while the first switches 133 are turned on. The second signal 134 can be provided by peripheral circuits 15 and 17, or other control circuits in the display apparatus 1 (not shown). However, people skilled in this field may use various circuits for providing the second signal 134, and thus, no unnecessary detail is given here. The detailed operations of the first switches 133 and the second switch 139 are as follows.

The reference voltage 130 is electrically connected to the capacitor 135, and transmitted to the capacitor 135 while the second switch 139 is turned on. The capacitor 135 is charged to a voltaic level after receiving the reference voltage 130. To electrically isolate the reference voltage 130 and the voltaic level of the data lines 114, 115 and 116, in the present embodiment, the second switch 139 is turned off while the first switches 133 are turned on. On the contrary, the first switches 133 are turned off while the second switch 139 is turned on. In one embodiment, the first signal 132 and the second signal 134 are out-of phase. However, the relationship between the first signal 132 and the second signal 134 is not limited to the present invention. For example, when the first switches 133 are P-type metal-oxide-semiconductor (MOS) transistors and the second switch 139 is an N-type MOS transistor, the first signal 132 and the second signal 134 are in-phase. People skilled in this field can understand the relation of the first switches 133 and the second switch by following the above-mentioned specification, and thus, no unnecessary detail is given here.

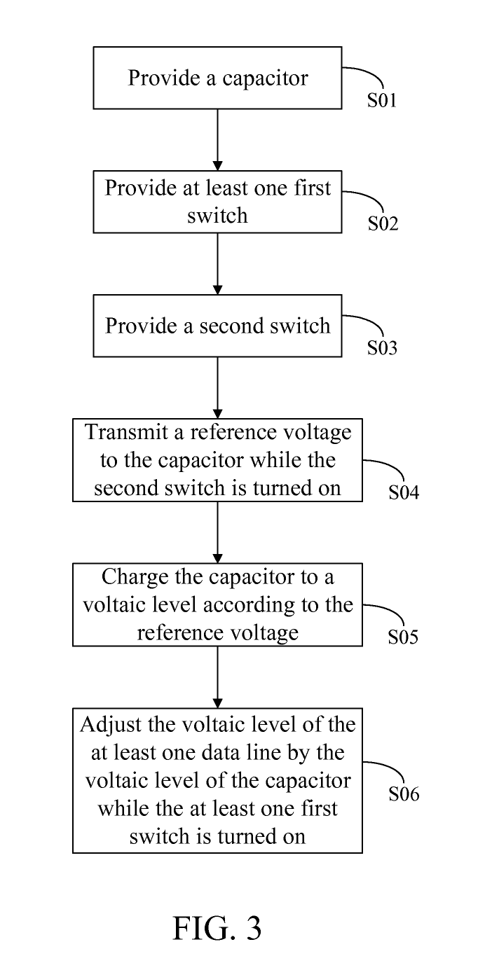

As shown in FIG. 3, the third embodiment of the present invention is a method for adjusting the voltaic level in a display apparatus. This method is applied to the display apparatus 2 described in the second embodiment.

Step S01 is to provide a capacitor, such as the capacitor 135, in the display apparatus of the second embodiment. In step S02, at least one first switch, such as the first switch 133 in the second embodiment, is provided and electrically connected to the capacitor and the at least one data line in the display apparatus of the second embodiment. In step S03, it is to provide a second switch, such as the second switch 139 in the display apparatus of the second embodiment, which is electrically connected to the capacitor. In step S04, a reference voltage is transmitted, such as the reference voltage 130 of the second embodiment, to the capacitor while the second switch is turned on. In step S05, the capacitor is charged to a voltaic level according to the reference voltage. Finally, in step S06, the voltaic level of the data line is adjusted, such as those in data lines 114, 115, and 116 in the second embodiment, by using the voltaic level of the capacitor while the first switch is turned on.

The present invention applies capacitors and switches to adjust the voltaic level of data lines of the display apparatus to control the voltaic level of the data lines in an adapted range. As a result, the driving circuit is able to provide the voltage and thus, the time for driving pixels can be reduced.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A voltaic level adjusting circuit, for used in a display apparatus having at least one data line, the voltaic level adjusting circuit comprising:
a capacitor adapted to be charged to a voltaic level after receiving a reference voltage; and
at least one first switch electrically connected to the at least one data line and the capacitor;
wherein a voltaic level of the at least one data line is adjusted by the voltaic level of the capacitor while the at least one first switch is turned on.

2. The voltaic level adjusting circuit according to claim 1, wherein;
the capacitor has a first electrode and a second electrode, the first electrode is electrically connected to the reference voltage and the second electrode is electrically connected to a first power source; and
the at least one first switch has a first end and a second end, the first end is electrically connected to the first electrode of the capacitor and the second end is electrically connected to the at least one data line.

3. The voltaic level adjusting circuit according to claim 1, further comprising a reference voltage circuit for providing the reference voltage.

4. The voltaic level adjusting circuit according to claim 3, wherein the reference voltage circuit has a dividing module electrically connected to a second power source and a third power source, and the dividing module provides the reference voltage according to the second power source and the third power source.

5. The voltaic level adjusting circuit according to claim 4, wherein the dividing module of the reference voltage circuit has a plurality of resistors.

6. The voltaic level adjusting circuit according to claim 3, further comprising a second switch electrically connected to the reference voltage circuit and the capacitor, the reference voltage being transmitted to the capacitor while the second switch is turned on.

7. The voltaic level adjusting circuit according to claim 6, wherein the display apparatus further comprises at least one drive circuit, the voltaic level adjusting circuit is adapted to receive a first signal and a second signal from the drive circuit, the at least one first switch is controlled by the first signal, and the second switch is controlled by the second signal.

8. A display apparatus, comprising:
at least one data line; and
a voltaic level adjusting circuit, comprising:
a capacitor adapted to be charged to a voltaic level after receiving a reference voltage; and
at least one first switch electrically connected to the at least one data line and the capacitor;
wherein a voltaic level of the at least one data line is adjusted by the voltaic level of the capacitor while the at least one first switch is turned on.

9. The display apparatus according to claim 8, wherein:
the capacitor has a first electrode and a second electrode, the first electrode is electrically connected to the reference voltage and the second electrode is electrically connected to a first power source; and
the at least one first switch has a first end and a second end, the first end is electrically connected to the first electrode of the capacitor and the second end is electrically connected to the at least one data line.

10. The display apparatus according to claim 8, wherein the voltaic level adjusting circuit further comprises a reference voltage circuit for providing the reference voltage.

11. The display apparatus according to claim 10, wherein the reference voltage circuit has a dividing module electrically connected to a second power source and a third power source, and the dividing module provides the reference voltage according to the second power source and the third power source.

12. The display apparatus according to claim 11, wherein the dividing module of the reference voltage circuit has a plurality of resistors.

13. The display apparatus according to claim 10, wherein the voltaic level adjusting circuit further comprises a second switch electrically connected to the reference voltage circuit and the capacitor, the reference voltage is transmitted to the capacitor while the second switch is turned on.

14. The display apparatus according to claim 13, wherein the display apparatus further comprises at least one drive circuit, the voltaic level adjusting circuit is adapted to receive a first signal and a second signal from the drive circuit, the at least one first switch is controlled by the first signal, and the second switch is controlled by the second signal.

15. A method for adjusting a voltaic level, for used in a display apparatus having at least one data line, the method comprising the steps of:
providing a capacitor;
charging the capacitor to a voltaic level according to a reference voltage;
providing at least one first switch; and
adjusting a voltaic level of the at least one data line by the voltaic level of the capacitor while the at least one first switch is turned on.

16. The method according to claim 15, further comprising the steps of:
providing a second switch; and
transmitting the reference voltage to the capacitor while the second switch is turned on.
